(19) United States
(12) Patent Application Publication
(10) Pub. No.: US 2004/0144162 A1
(43) Pub. Date: Jul. 29, 2004

(54) Process for preconditioning assembled parts for leak testing

(76) Inventors: Stephen A. Berggren, Carmel, IN (US); Christopher T. Grigsby, Kokomo, IN (US); Heather Hude, Atlanta, GA (US); Mary Pat Stahl, West Lafayette, IN (US); Steven E. Staller, Russiaville, IN (US); Stephen P. Long, Tipton, IN (US)

Correspondence Address: Jimmy L. Funke, Delphi Technologies, Inc., Legal Staff, CT10C, P.O. Box 9005, Kokomo, IN, 46904-9005, US

(21) Appl. No.: 10/352,560

(22) Filed: Jan. 28, 2003

(51) Int. Cl. G01M 3/04

(52) U.S. Cl. 73/40.7

(57) ABSTRACT

A process for preconditioning assembled parts for leak testing is disclosed. The process includes placing the assembled parts under vacuum to draw out through any unsealed interface of the assembled parts any fluid trapped therein, and while under vacuum, exposing the assembled parts to a liquid conditioning medium (LCM), wherein the LCM may comprise a mixture of water and a low vapor pressure surfactant. The assembled parts exposed to the LCM are then placed under positive pressure greater than ambient pressure to drive the LCM into any unsealed interfaces of the assembled parts. Any residual LCM on the external surfaces of the assembled parts is then removed, and the assembled parts are subsequently tested for LCM ingress.

### TECHNICAL FIELD

The present invention relates generally to techniques for performing leak testing on assembled parts, and more specifically to techniques for preconditioning the assembled parts for subsequent leak testing.

### BACKGROUND OF THE INVENTION

Many assembled parts are known to require bonding of two or more component pieces together to form hermetically sealed interfaces or bonds therebetween. It is generally understood that the integrity of such interfaces may become compromised due to malformation of the one or more interfaces during manufacture thereof, and/or damage done to the one or more interfaces resulting from mishandling of the assembled parts. In either case, a breach in one or more of the interfaces results, which invites the ingress of fluids and/or other contaminants.

Known leak tests have been developed to evaluate the integrity of one or more sealed interfaces of assembled parts, and some such leak tests are configured to test for moisture ingress into the assembled parts that has occurred through one or more breached interfaces or seals. While many such leak and/or moisture ingress tests perform adequately, even the best leak or moisture ingress test will be ineffective in determining the existence of breached interfaces or seals in assembled parts if no moisture or other contaminants have effectively penetrated such parts.

What is therefore needed is a process for preconditioning assembled parts including one or more interfaces or bonds between component pieces thereof to ensure that detectable amounts of moisture penetrate breached ones of such interfaces or bonds. Subsequent leak and/or moisture ingress tests may then more effectively discern assembled parts having breached seals or interfaces from those that do not.

### SUMMARY OF THE INVENTION

The present invention comprises one or more of the following features or combinations thereof. A process for preconditioning an assembled part for leak testing may comprise placing the assembled part under vacuum to draw out through any unsealed interface of the assembled part any fluid trapped therein. While under vacuum, the assembled part may be exposed to a liquid conditioning medium (LCM). The assembled part exposed to the LCM may then be placed under positive pressure greater than ambient pressure to drive the LCM into any unsealed interface of the assembled part. Thereafter, the assembled part may be tested for LCM ingress. The LCM may be a mixture of water and a low vapor pressure surfactant.

The step of placing the assembled part under vacuum may include providing a closable chamber, placing the assembled part into the closable chamber and closing the chamber and establishing the vacuum in the closed chamber. The step of exposing the assembled part to a liquid conditioning medium may include dispensing the LCM into the closed chamber while the chamber is under vacuum. The step of dispensing the LCM into the closed chamber may include dispensing the LCM into the closed chamber in sufficient quantity to cover the assembled part. The step of placing the assembled part exposed to the LCM under positive pressure may include establishing the positive pressure within the closed chamber.

The process may further include the step of reducing the pressure within the closed chamber to ambient pressure after the step of placing the assembled part exposed to the LCM under positive pressure but before the step of testing the assembled part.

The process may further still include removing any residual LCM from all external surfaces of the assembled part after the step of reducing the pressure within the closed chamber to ambient pressure but before the step of testing the assembled part.

The step of removing any residual LCM from all external surfaces of the assembled part may include rinsing all external surfaces of the assembled part with water, wherein this step may include controlling the flow rate or pressure of the water to be sufficiently high to remove residual LCM from all external surfaces of the assembled parts, yet sufficiently low to avoid removing the LCM that has penetrated the assembled part.

The step of removing any residual LCM from all external surfaces of the part may further include spinning the assembled part, which may include spinning the part in a rotary spinning apparatus at a spinning speed that is sufficiently high to promote drying of all external surfaces of the part, yet sufficiently low so that the LCM that has penetrated the assembled part remains within the assembled part.

The step of removing any residual LCM from all external surfaces of the part may further include blow drying the assembled part with a positive flow of gas, which may include controlling the flow rate or pressure of the gas applied to the assembled part to be sufficiently high to promote drying of all external surfaces of the part, yet sufficiently low to avoid drying the LCM that has penetrated the assembled part and so that the LCM that has penetrated the assembled part remains within the assembled part.

The assembled part may include a first substrate bonded to a second substrate via a sealing member to form a cavity therebetween, wherein the unsealed interface of the assembled part may be a breach in either or both of a first bond between the first substrate and the sealing member and a second bond between the second substrate and the sealing member, wherein any such breach may allow ingress of the LCM into the cavity.

Another process of preconditioning an assembled part for leak testing, wherein the assembled part comprises first and second substrates bonded together via a bonding member to form a cavity therebetween, may comprise placing the assembled part under vacuum to draw out through any unsealed interface between either of the first and second substrates and the bonding member any fluid trapped in the cavity. While under vacuum, a liquid conditioning medium may be dispensed onto and about the assembled part such that it is completely immersed in a liquid conditioning medium (LCM). The assembled part thus immersed in the LCM may then be placed under positive pressure greater than ambient pressure to drive the LCM through any unsealed interface and into the cavity. The assembled part may then be tested, after exposure to the positive pressure, for LCM ingress into the cavity. The LCM may be a mixture of water and a low vapor pressure surfactant.

The process may further include removing any residual LCM from all external surfaces of the assembled part after the step of placing the assembled part under positive pressure but before the step of testing the assembled part.

The process may further still include reducing the positive pressure to ambient pressure after the step of placing the assembled part under positive pressure but before the step of removing any residual LCM.

The step of removing any residual LCM from all external surfaces of the assembled part may include rinsing all external surfaces of the assembled part, spinning the assembled part in a rotary spinning apparatus after the rinsing step, and blow drying all external surfaces of the assembled part with a positive flow of gas after the spinning step.

These and other features of the present invention will become more apparent from the following description of the illustrative embodiments.

### BRIEF DESCRIPTION OF THE DRAWINGS

FIG. 1 is a cross-sectional view of a conventional assembled part comprising first and second substrates bonded together via a bonding member to form a cavity therebetween.

FIG. 2 is a diagrammatic illustration of one embodiment of an apparatus for preconditioning an assembled part, such as the assembled part illustrated in FIG. 1, for subsequent leak testing.

FIG. 3 is a flowchart illustrating one embodiment of a process for preconditioning an assembled part for subsequent leak testing using the apparatus of FIG. 2.

### DESCRIPTION OF THE ILLUSTRATIVE EMBODIMENTS

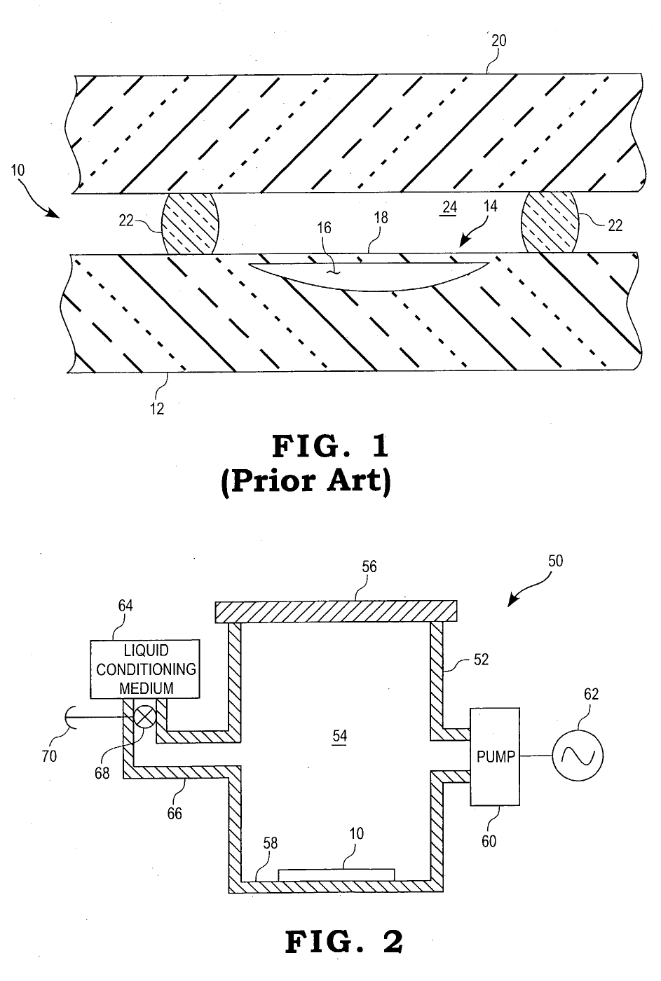

The present invention is directed to a process for preconditioning assembled parts for subsequent leak testing to determine whether any one or more sealed interfaces of the assembled parts have been breached. Generally, the process of the present invention should be understood to be applicable to any assembled part having one or more sealed interfaces that would allow ingress of fluid therein upon a breach of any one or more such sealed interfaces. For purposes of this document, the process will be described as it relates to one illustrative assembled part 10 shown in FIG. 1, it being understood that the process described herein is applicable to a broader class of parts of the type just described.

Referring now to FIG. 1, a cross-sectional view of one illustrative embodiment of a conventional assembled part 10 is shown. Assembled part 10 includes first and second substrates 12 and 20 bonded together via a bonding member 22 to form a cavity 24 therebetween. In the illustrated embodiment, the first substrate 12 is a semiconductor substrate having a top surface 18 in which at least one suspended electronic circuit component 14 has been defined over a pit or depression 16 via micromachining, etching, or other known technique. As one example, the electronic circuit component 14 may include one or more resistors suspended over the pit or depression 16 to form a semiconductor accelerometer as is known in the art.

In general, electronic circuits and/or circuit components formed in the surfaces of semiconductor substrates of the type illustrated in FIG. 1 fall into the general class of micro-electromechanical systems (MEMS), and care must be taken during the processing of such systems so as not to damage the integrity of the one or more suspended circuit components. It is accordingly conventional to affix or bond a top, or so-called “cap” substrate 20, typically comprising at least a portion of a semiconductor wafer, over the circuit carrying substrate 12 to protect the one or more circuit components 14 from contamination and/or damage during assembly of the substrate 12 into an electronic system. One conventional technique of bonding the cap substrate 20 to the component substrate 12 includes providing one or more glass frits 22 or other suitable bonding member or members between the two substrates 12 and 20 to form a cavity 24 between the substrates 12 and 20 over the circuit component 14, and bonding the one or more glass frits 22 to both substrates 12 and 20 via known thermal or thermal compression techniques, to form hermetically sealed interfaces or bonds between the one or more glass frits 22 and the each of the substrates 12 and 20. The process described herein is directed to techniques for preconditioning assembled parts, such as assembled part 10 of FIG. 1, prior to leak testing to determine whether any moisture has penetrated such assembled parts and thereby identify assembled parts having one more breached seals or interfaces between component pieces thereof.

Referring now to FIG. 2, one illustrative embodiment of an apparatus 50 is shown for preconditioning an assembled part, such as the assembled part 10 illustrated in FIG. 1, for subsequent leak testing. Apparatus 50 includes a closable chamber unit 52 defining a chamber 54 therein and a chamber top 56, configured to sealingly engage the chamber unit 52 when closed as illustrated in FIG. 2. The chamber 54 includes a chamber bottom 58 configured to support any number of assembled parts 10 therein, although only one such assembled part 10 is illustrated as being contained within chamber 54 in FIG. 2.

Apparatus 50 includes a pump 60 of known construction and fluidly coupled to chamber 54. In the illustrated embodiment, pump 62 is electronically controllable via an electronic control unit 62, to selectively establish a desired vacuum and/or positive pressure within chamber 54. Alternatively or additionally, pump 60 may include mechanical controls for controlling the vacuum/pressure within chamber 54. Alternatively still, pump 60 may be replaced by two separate pumps, one dedicated to establishing a vacuum within chamber 54 and the other dedicated to establishing a positive pressure, greater than ambient pressure, within chamber 54.

Apparatus 50 further includes a source of liquid conditioning medium (LCM) 64 fluidly coupled to chamber 54 via conduit 66. A conventional valve 68 is provided, and is controlled by a conventional valve control mechanism 70, for selectively dispensing the LCM 64 into the chamber 54 via conduit 66. The LCM 64 is generally configured to facilitate and maximize penetration of the LCM 64 into an assembled part 10 via any unsealed interface thereof, while also to maximizing the drying time of any such LCM 64 that has penetrated the assembled part 10. In one embodiment, the LCM 64 is a mixture of water and a low vapor pressure surfactant, wherein the low vapor pressure surfactant is Octylphenoxypolyethoxyethanol. One specific water/Octylphenoxypolyethoxyethanol mixture that is well-suited for use as LCM 64 comprises approximately 99.5% water and 0.5% Octylphenoxypolyethoxyethanol, and such a mixture is commercially available from Union Carbide Chemical & Plastics Co., Inc. of Danbury, Conn. as Triton X-100. It is to be understood that other water/Octylphenoxypolyethoxyethanol compositions may be used, wherein any such other compositions will typically be dictated by the application. Those skilled in the art will also recognize that other surfactants may be used to form LCM 64, wherein it is desirable for any such alternate surfactant to have a vapor pressure characteristic that is sufficiently low to avoid evaporation or separation of the surfactant from the water under vacuum, and examples of such other surfactants include, but are not limited to Fluorad fluorochemical surfactant, as manufactured by 3M Co. of St. Paul, Minn., Tergitol Nonionic Surfactant min-foam 1X, as manufactured by Union Carbide Chemical & Plastics Co., Inc. of Danbury, Conn., and the like.

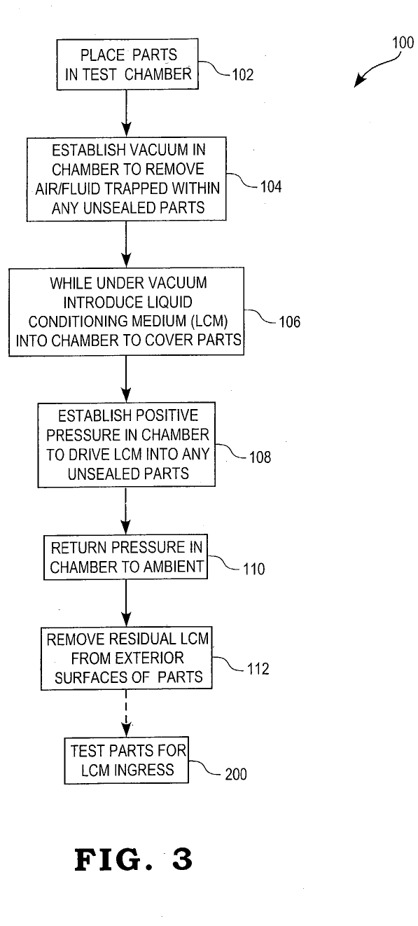

Referring now to FIG. 3, a flowchart is shown illustrating one embodiment of a process 100 for preconditioning an assembled part 10 for subsequent leak testing using the apparatus 50 of FIG. 2. Process 100 begins at step 102 where one or more of the assembled parts 10 are placed into the chamber 54 and the lid or top 56 thereafter closed. Thereafter at step 104, a vacuum is established in the chamber 54 via pump 60 to remove fluid trapped within any of the assembled parts 10 having one or more breached seals or interfaces. As used in this context, the term “fluid” may include any gas or gas composition, any liquid or liquid composition, and/or any combination of gas or gas composition and liquid or liquid composition. In one embodiment, the vacuum established within chamber 54 at step 104 is set at approximately 800 milliTorr for approximately 600 seconds, although those skilled in the art will recognize that the vacuum level and/or time duration may vary as desired at step 104 depending upon the application.

Following step 104, process 100 advances to step 106 where the liquid conditioning medium (LCM) 64 is introduced into the chamber 54 while the chamber 54 is still under vacuum. It is because the LCM 64 is introduced into chamber 54 while still under vacuum that it is desirable for the surfactant to have low vapor pressure properties, as described hereinabove, to thereby avoid evaporating or otherwise separating the surfactant from the water under vacuum. Those skilled in the art will recognize that different levels of vacuum will generally require different low vapor pressure characteristics to avoid evaporation or separation of the surfactant from the water, and the vacuum level and duration established at step 104 may accordingly influence, at least in part, the choice of surfactant.

In one embodiment, a sufficient quantity of LCM 64 is introduced into the chamber 54 at step 106 to completely cover all of the assembled parts 10 contained therein such that all of the assembled parts 10 contained within the chamber 54 are entirely immersed within the LCM 64. However, those skilled in the art will recognize other applications wherein the one or more assembled parts 10 within chamber 54 need only be exposed to some lesser quantity of LCM 64. In any case, process advances from step 106 to step 108 where a positive pressure, greater than ambient pressure, is established in the chamber 54 via pump 60 to drive the LCM 64 into any of the assembled parts having a breached bond or interface between any component pieces comprising the parts 19. Where the assembled parts are those of the type illustrated in FIG. 1, for example, step 108 acts to drive the LCM 64 into the cavities 24 of such parts via any breach in the seal or bond between the circuit-carrying substrates 12 and the bonding members 22 and/or in the seal or bond between the cap substrates 20 and the bonding members 22. In one embodiment, the pressure established within chamber 54 at step 108 is set at approximately 50 psi for approximately 600 seconds, although those skilled in the art will recognize that the pressure level and/or time duration may vary as desired at step 108 depending upon the application.

Following step 108, process 100 advances to step 110 where the pump 60 is controlled to reduce the pressure within the chamber 54 back to ambient pressure so that the lid or top 56 may be opened and the one or more assembled parts 10 extracted from the chamber 54. Thereafter at step 112, any residual LCM is removed from the exterior surfaces of the one or more assembled parts 10. Generally, it is desirable to remove all of the residual LCM from the exterior surfaces of the one or more assembled parts 10 while also maintaining as much as possible of the LCM 64 that has penetrated any of the parts 10 within these parts 10 for subsequent leak testing.

In one embodiment of process 100, step 112 comprises three sub-steps; namely rinsing all of the exterior surfaces of the one or more assembled parts 10, spinning the one or more parts 10 in a conventional rotary spinning apparatus, and blow drying all of the exterior surfaces of the one or more assembled parts 10 with a positive flow of a gas. It is desirable in the rinsing sub-step of step 112 for the water flow rate and/or pressure to be controlled to a level that is sufficiently high to remove all of the residual LCM 64 from all external surfaces of the assembled parts 10, yet is sufficiently low to avoid removing any of the LCM 64 that has penetrated the assembled parts 10. In one embodiment of step 112, for example, all of the external surfaces of the one or more assembled parts 10 are rinsed with water at a pressure of approximately 15 MPa for a duration of approximately 300 seconds, although those skilled in the art will recognize that the water flow and/or pressure and/or rinsing duration may vary depending upon the application.

It is desirable in the spinning sub-step of step 112 for the spinning speed of the rotary spinning apparatus to be controlled to a speed that is sufficiently high to promote drying of all external surfaces of the part, yet sufficiently low so that any of the LCM 64 that has penetrated the assembled part 10 remains within the assembled part 10. In one embodiment of step 112, for example, the spinning speed of the rotary spinning apparatus is set at approximately 300 RPM for approximately 280 seconds, although those skilled in the art will recognize that the spinning speed and/or duration may vary depending upon the application.

It is desirable in the blow drying sub-step of step 112 for the gas flow rate and/or pressure to be controlled to a level that is sufficiently high to promote drying of all external surfaces of the part 10, yet is sufficiently low to avoid drying any of the LCM 64 that has penetrated the assembled part 10 and so that any of the LCM 64 that has penetrated the assembled part 10 remains within the assembled part 10. In one embodiment of step 112, for example, all of the external surfaces of the one or more assembled parts 10 are blown dry with nitrogen at a pressure of approximately 0.5 MPa for a duration of approximately 300 seconds, although those skilled in the art will recognize that the gas flow and/or pressure and/or drying duration may vary depending upon the application. It should further be understood that the choice of gas may also vary depending upon the application, and suitable examples of alternative gases that may be used at the blow drying sub-step include, but are not limited to, ambient air, filtered air, or other suitable drying gas.

Following step 112, process 100 advances to step 200 where the one or more assembled parts 10 are tested, according to a conventional leak test, for ingress of the LCM 64. It will be understood that step 200 may comprise any known test for determining whether and/or to what degree, the LCM 64 has penetrated any of the assembled parts 10. In one embodiment, for example, step 200 is carried out in accordance with a known electrical verification of seal (ELVIS) test, although other known LCM 64 ingress test techniques may be substituted therefor to determine whether any moisture carried by the LCM 64 has penetrated any one or more of the assembled parts 10 resulting from a breach of one or more seals or interfaces of any one or more of the assembled parts 10.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

1. A method of preconditioning an assembled part for leak testing, the method comprising the steps of;
placing the assembled part under vacuum to draw out through any unsealed interface of the assembled part any fluid trapped therein;
while under vacuum, exposing the assembled part to a liquid conditioning medium (LCM);
placing the assembled part exposed to the LCM under positive pressure greater than ambient pressure to drive the LCM into said any unsealed interface of the assembled part; and
testing the assembled part that has been exposed to the LCM under positive pressure for LCM ingress.

2. The method of claim 1 wherein the step of placing the assembled part under vacuum includes:
providing a closable chamber;
placing the assembled part into the closable chamber and closing the chamber; and
establishing the vacuum in the closed chamber.

3. The method of claim 2 wherein the step of exposing the assembled part to a liquid conditioning medium includes dispensing the LCM into the closed chamber while the chamber is under vacuum.

4. The method of claim 3 wherein the step of dispensing the LCM into the closed chamber includes dispensing the LCM into the closed chamber in sufficient quantity to cover the assembled part.

5. The method of claim 4 wherein the step of placing the assembled part exposed to the LCM under positive pressure includes establishing the positive pressure within the closed chamber.

6. The method of claim 5 further including the following step after the step of placing the assembled part exposed to the LCM under positive pressure but before the step of testing the assembled part:
reducing the pressure within the closed chamber to ambient pressure.

7. The method of claim 6 further including the following step after the step of reducing the pressure within the closed chamber to ambient pressure but before the step of testing the assembled part:
removing any residual LCM from all external surfaces of the assembled part.

8. The method of claim 7 wherein the step of removing any residual LCM from all external surfaces of the assembled part includes rinsing all external surfaces of the assembled part with water.

9. The method of claim 8 wherein the step of rinsing all external surfaces of the assembled part with water includes controlling one of a flow rate and a pressure of the water applied to the assembled part to be sufficiently high to remove residual LCM from all external surfaces of the assembled parts, yet sufficiently low to avoid removing the LCM that has penetrated the assembled part.

10. The method of claim 9 wherein the step of removing any residual LCM from all external surfaces of the part further includes spinning the assembled part in a rotary spinning apparatus.

11. The method of claim 10 wherein the step of spinning the assembled part includes spinning the part at a spinning speed that is sufficiently high to promote drying of all external surfaces of the part yet sufficiently low so that the LCM that has penetrated the assembled part remains within the assembled part.

12. The method of claim 11 wherein the step of removing any residual LCM from all external surfaces of the part further includes blow drying the assembled part with a positive flow of gas.

13. The method of claim 12 wherein the step of blow drying the assembled part includes controlling one of a flow rate and a pressure of the gas applied to the assembled part to be sufficiently high to promote drying of all external surfaces of the part yet sufficiently low to avoid drying the LCM that has penetrated the assembled part and so that the LCM that has penetrated the assembled part remains within the assembled part.

14. The method of claim 1 wherein the LCM as a mixture of water and a low vapor pressure surfactant.

15. The method of claim 1 wherein the assembled part includes a first substrate bonded to a second substrate via a sealing member to form a cavity therebetween;
and wherein said any unsealed interface of the assembled part includes a breach in either of a first bond between the first substrate and the sealing member and a second bond between the second substrate and the sealing member, any such breach allowing ingress of the LCM into the cavity.

16. A method of preconditioning an assembled part for leak testing, the assembled part comprising first and second substrates bonded together via a bonding member to form a cavity therebetween, the method comprising the steps of;
placing the assembled part under vacuum to draw out through any unsealed interface between either of the first and second substrates and the bonding member any fluid trapped in the cavity;
while under vacuum, completely immersing the assembled part into a liquid conditioning medium (LCM);
placing the assembled part immersed in the LCM under positive pressure greater than ambient pressure to drive the LCM through said any unsealed interface and into the cavity; and
testing the assembled part after exposure to the positive pressure for LCM ingress into the cavity.

17. The method of claim 16 further including the following step after the step of placing the assembled part under positive pressure but before the step of testing the assembled part:
removing any residual LCM from all external surfaces of the assembled part.

18. The method of claim 17 further including the following step after the step of placing the assembled part under positive pressure but before the step of removing any residual LCM:
reducing the positive pressure to ambient pressure.

19. The method of claim 17 wherein the step of removing any residual LCM from all external surfaces of the assembled part includes:
rinsing all external surfaces of the assembled part;
spinning the assembled part in a rotary spinning apparatus after the rinsing step; and
blow drying all external surfaces of the assembled part with a positive flow of gas after the spinning step.

20. The method of claim 16 wherein the LCM is a mixture of water and a low vapor pressure surfactant.
